(19) United States
(12) Patent Application Publication
(10) Pub. No.: US 2024/0380086 A1
(43) Pub. Date: Nov. 14, 2024

(54) FUSED BUTTON BATTERY

(71) Applicants: Technische Universiteit Delft, Delft (NL); Rijksuniversiteit Groningen, Groningen (NL); Academisch Ziekenhuis Groningen, Groningen (NL)

(72) Inventors: Marnix WAGEMAKER, Delft (NL); Tjark EBELS, Delft (NL); Frederik Gerhard DIKKERS, Delft (NL); Fransiscus Guntherus Bernardus OOMS, Delft (NL)

(73) Assignees: Technische Universiteit Delft, Delft (NL); Rijksuniversiteit Groningen, Groningen (NL); Academisch Ziekenhuis Groningen, Groningen (NL)

(21) Appl. No.: 18/259,991

(22) PCT Filed: Dec. 24, 2021
(86) PCT No.: PCT/NL2021/050787

§ 371 Date: Jun. 29, 2023

(30) Foreign Application Priority Data
Dec. 30, 2020 (NL) 2027247
Nov. 17, 2021 (NL) 2029793

(51) Int. Cl. H01M 50/583; H01M 50/109

(52) U.S. Cl. CPC H01M 50/583; H01M 50/109; H01M 2200/103

(57) ABSTRACT

The present invention relates to a single cell cylindrical battery, such as a button cell or a button battery, that can be regarded to have the shape of a slice of a cylinder, and to a method preventing upper digestive and upper respiratory tract injury after accidental ingestion of the single cell cylindrical battery. It is noted that in some case ingestion has even led to the death in particular of children or small size adults, or people with a mental limitation, or people with a prior narrowing of structures in which the battery can be lodged. The structures in which the battery can be lodged are both the pharyngeal, upper digestive and upper respiratory tracts. As ingestion itself can not always be prevented, a relatively safe battery has been developed, which mitigates problems associated with ingestion.

### FIELD OF THE INVENTION

The present invention relates to a single cell cylindrical battery, such as a button cell, or a button battery, or a watch battery, that can be regarded to have the shape of a slice of a cylinder, and to a method preventing upper digestive tract injury after accidental ingestion of the single cell cylindrical battery. It is noted that in some case ingestion has even led to the death in particular of children or small size adults, or people with a mental limitation or people with a prior narrowing of structures in which the battery can be lodged. The structures in which the battery can be lodged are both the digestive and upper respiratory tracts. As ingestion itself can not always be prevented, a relatively safe battery has been developed, which mitigates problems associated with ingestion.

### BACKGROUND OF THE INVENTION

The invention is in the field of a single cell cylindrical battery, also referred to as a watch battery or a button cell. Typically, it relates to a small cell shaped as a typically short cylinder. A diameter thereof is typically limited to 5 to 25 mm whereas a height typically is 1 to 6 mm, hence relatively small objects. Button cells with relatively larger diameters are typically referred to as coin cells. Primary and secondary button batteries comprise an electrochemical stack typically enclosed by a metal casing. A typical casing comprises a metal bottom can and a metal top cap which are electrically isolated from each other, such as by a polymer gasket. The bottom casing is typically crimped or deformed around the cap in the manufacturing process resulting in a tight seal. Typically, the internal surfaces of the can and cap are connected to the cathode electrode and the anode electrode of the electrochemical stack, respectively, and therefore may be considered to act as the positive and negative terminal of the button cell. Typically, these internal contacts are established by the pressure resulting from the deformation and the manufacturing process. As other batteries, button cells can be used to provide electronics devices with power, typically relatively small electronic devices. Most button cells have low self-discharge and hold their charge for a long time if not used.

Button cells may be considered as primary cells, which unfortunately are usually disposable primary cells, as opposed to secondary cells that can be reversible charged/discharged. Common anode materials are zinc or lithium. Common cathode materials are manganese dioxide, silver oxide, carbon monofluoride, cupric oxide or oxygen from the air. Relatively high-power devices may use a zinc-air battery which have much higher capacity for a given size.

Cells are typically mechanically interchangeable. However, voltage, amperage, power output may vary significantly. In view of intended use cells are optimised for different loads, such as by using different electrolytes.

Button cells are found to be potentially very dangerous in particular for aforementioned categories of people. Button cells that are swallowed can result in severe damage of vital organs that may result in death. In this respect reference can be made to Voelker J, et al., “Severe tracheobronchial harm due to lithium button battery aspiration: An in vitro study of the pathomechanism and injury pattern.”, Int. J. Pediatr. Otorhinolaryngol. 2020 December; 139:110431, and Jatana K R, et al., “Button battery safety: industry and academic partnerships to drive change.” Otolaryngol Clin North Am. 2019;52:149-161. Basic mechanisms of such injury have been described in Jatana K R, Rhoades K, Milkovich S, Jacobs I N. Basic mechanism of button battery ingestion injuries and novel mitigation strategies after diagnosis and removal. Laryngoscope. 2017 June; 127 (6): 1276-1282 Reference may also be made to P. Doekes in “Button battery induced oesophageal lesions: how and when?”, MSC thesis, R. U. Groningen, July 2015.

Some documents relate to discoursing children from ingesting batteries, such as having batteries with unpleasant taste, or unpleasant colour. Some button batteries may be provided with an adhesive sticker for preventing a short-circuit by sealing of one or both of the electrodes. This may prevent some accidents from happening in the first place and the latter only functions for new (non-used) batteries. Experiments demonstrate that this yields a deceptive sense of security, as the seal of the stickers is never electrically complete.

Some documents recite button cells with a coil electrode with thermal securing. For instance, EP 3252843 A1 recites a button cell which comprises a housing, an electrode-separator assembly, and metallic diverters, which electrically connect the at least one positive electrode and the at least one negative electrode to one of the housing halves each, and at least one of the diverters is provided with a thermal fuse, which respond to a temperature difference rather than to an electric short-cut.

Some documents recite fuses to prevent thermal explosions. And some documents provide materials that change electrical properties, in that a conductive path is transferred into a non-conducting path, e.g., from a stress to a non-stress status. And some further documents recite fuses in battery-systems, in order to prevent too strong currents in said system as a whole.

Some documents refer to fused batteries. For instance, US 2013/202922 A1 recites a polymer-fused battery including a casing, an anode coupled to the casing, an electrical source disposed between the casing and the anode, and a fuse over at least a portion of the anode. The polymer fuse comprises an electrically-conductive material formulated to decompose upon contact with a bodily fluid and to provide electrical communication between the anode cap and the electrical source when the polymer fuse is intact. And EP 3 588 622 A1 recites a disc fuse including an electrically insulating substrate having a via formed therethrough extending between a first surface and a second surface of the substrate, an electrically conductive first terminal disposed on the first surface of the substrate, and an electrically conductive second terminal disposed on the second surface of the substrate, the second terminal including an outer portion having an inner edge defining a through-hole in the second terminal, the second terminal further including a fuse portion extending from the inner edge, the fuse portion comprising a fusible element terminating in a contact pad, wherein the substrate provides an electrically insulating barrier between the first terminal and the second terminal and wherein the via provides an electrical connection between the first terminal and the contact pad.

Therefore, there is a need for an improved single cell cylindrical battery.

The present invention therefore relates to a single cell cylindrical battery and further aspects thereof, which overcomes one or more of the above disadvantages, without compromising functionality and advantages.

### SUMMARY OF THE INVENTION

It is an object of the invention to overcome one or more limitations of a single cell cylindrical battery of the prior art and at the very least to provide an alternative thereto. The present single cell cylindrical battery, such as a button cell or a button battery, comprising at least one positive electrode (eₚ), at least one negative electrode (eₙ), in between said electrodes at least one solid or fluid electrolyte (eₙ), at least one positive terminal (tₚ) in electrical contact with the at least one positive electrode, at least one negative terminal (tₙ) in electrical contact with the at least one negative electrode, and at least one electrical fuse (f) in between and in electrical contact with said negative or positive electrode and said negative or positive terminal, respectively, wherein the at least one fuse comprises a dielectric material, in particular at least one dielectric layer (d), and wherein the at least one electrical fuse (f) is embedded in said dielectric material. The present fuse may be regarded as an electrically conductive element that loses the ability to conduct the electrical current in a controlled and predefined manner. In general, a fuse is regarded an electrical safety device that provides overcurrent protection of an electrical circuit. Its main component is typically a metal wire or metal strip that is adapted to melt when too much current flows through it. Evidently it then stops the current from flowing. As it melts, it may be considered to be a sacrificial device; once a fuse has operated it results in an open circuit, and the present battery is as a consequence not functioning as such any longer. Fuses may be designed to have specific current and voltage ratings, breaking capacity and response times, depending on the application. The time and current operating characteristics of fuses are chosen to provide adequate protection without jeopardizing functionality. Wiring regulations usually define a maximum fuse current rating for particular circuits. A fuse is therefore a means of removing power. The present single cell cylindrical battery provides a simple solution to the above problems, which prevents continuous discharging of the present battery, especially when ingested, such as by children. The inventors indicate that the external short circuit caused by an ingested battery results in a current peak above 0.2 Ampere, whereas the maximum current use of button cells is approximately 0.1 Ampere at a limited time interval of less than 15 sec, typically less than 5 sec. The invention is a fuse that operates within this current window, not affecting the normal working and breaking the short circuit upon ingestion. Therewith the present battery largely prevents injury resulting from discharging when ingested, by breaking the circuit, resulting in only a fraction of the reactions that cause the injury. Most or all of serious injury is there-with prevented, as well as casualties. The present fuse can be integrated in an existing or new single cell cylindrical battery without any major changes, amongst others in view of the flat design of the fuse. The present battery is therefore safer.

Details of the present single cell cylindrical battery can e.g. be found in IEC60086, which international standard document and its contents are incorporated by reference. The term “watch battery” is considered to be encompassed by the present single cell cylindrically battery. To give some examples: type B or C systems (Li-based) have a nominal voltage of 3.0 V, and end-point voltage of 2.0 V, and an open circuit voltage of 3.00-3.70 V. Type L or S systems (Zn-based) have a nominal voltage of about 1.5 V, and end-point voltage of 1.0/1.2 V, and an open circuit voltage of 1.50-1.70 V. A discharge resistance is in the order 10-100 kΩ.

In a further aspect the present invention relates to a method of preventing injury after accidental ingestion of the single cell cylindrical battery according to the invention, in particular of children, or small sized adults, or people with a mental limitation, or people with a prior narrowing of digestive or upper respiratory tract, or in the mouth, or in the nose, or in the pharynx., comprising providing the single cell cylindrical battery, preventing short circuit by the at least one electrical fuse (f) which at least one electrical fuse breaks the short circuit when ingested. A reason that specifically children (or likewise small human beings) suffer most, is that ingestion of a single battery is found to cause a short circuit in the oesophageal region, where it often becomes lodged and does not pass through the digestive tract. When for instance a button battery is ingested, in particular one with a diameter of 20 mm, the ionically conducting environment of the upper digestive tract of children effectively creates an external short circuit of the battery. This is found to drive a local chemical reaction raising the pH near one pole of the battery and lower the pH near the other pole. The non-physiological pH is found to effectively dissolve the local wall, leading to the injury of adjacent tissue.

It is found that upon stress, such as caused by a current of the present battery when ingested, a concentration of electrolytes may actually increase significantly, up to a factor five higher. A typical concentration of electrolytes is in the order of 1-500-10⁻³ mol/l, such as 45-165-10⁻³ mol/l.

The present invention provides a solution to one or more of the above mentioned problems and overcomes drawbacks of the prior art.

Advantages of the present invention are detailed throughout the description.

### DETAILED DESCRIPTION OF THE INVENTION

In an exemplary embodiment of the present single cell cylindrical battery the electrical fuse (f) comprises a short peak current amplifier (SPCA), that relates to a discharge peak-current or shorting current amplifier, preferably wherein the short peak current amplifier comprises a saliva soluble electrical insulator, such as a salt, and optionally a saliva soluble adhesive, that is, the insulator and optional adhesive are in solid or semi-solid form. Typically saliva solubility can be taken to be similar to water solubility; the saliva may in certain cases provide a better solubility in view of components present in the saliva, such as enzymes. The solubility of the saliva soluble electrical insulator, typically a salt, is preferably >0.01 mole/l (@273 K), more preferably >0.1 mole/l, such as 0.5-10 mole/l, The energy of dissolution ΔG (273 K) is preferably relatively small, such as <20 KJ/mole. The salt is preferably non-toxic. In view of the saliva soluble insulator salts and strong electrolytes such as NaCl, are considered. Typically the electrical conductivity of these salts as such, at 20° C., is <1 S/m, preferably <10⁻² S/m, whereas upon dissolution into water the ionic conductivity is 0.1-100 S/m, such as 1-10 S/m. The adhesive is preferably a non-conductive in semi-solid form. The solution into the watery saliva is typically quick, in line with the insulator. The glue is preferably non-toxic. The glue preferably has an added characteristic, such as a colour, to make the button battery distinctive from non-fused button batteries. Typically the SPCA is accessible from the outside by at least one opening.

A ring shaped SPCA may be considered, such as consisting of salt granules, preferably packed in a saliva soluble glue, such as a starch, resulting in a paste like semi-solid substance. It may be used to cover the area where positive and negative electrodes are separated by the standard insulator. It is noted that button batteries are commonly preserved in a dry surrounding so that the ring shaped SPCA does not interfere with normal operating characteristics. Upon ingestion, however, the oral and oesophageal saliva will dissolve the SPCA, whereupon a high local concentration of electrolytes will increase the temporal conductivity, resulting in an amplified peak current. The duration of the peak conductivity will depend on the local concentration, because the electrolytes will dissolve and dissipate into the saliva.

In an exemplary embodiment of the present single cell cylindrical battery the electrical fuse (f) comprises at least one longitudinal piece of memory metal, in particular at least two individual longitudinal pieces, wherein the at least one longitudinal piece is in contact with said negative terminal and said positive terminal at a temperature above 30° C., preferably at a temperature above 35° C., and wherein the at least one longitudinal piece is not in contact with at least one of said negative terminal and said positive terminal at a temperature below 30° C., preferably at a temperature below 25° C. An example of such a memory metal may even be a spring, such as a stainless steel spring. The resistivity of the at least one longitudinal piece of memory metal is in particular <10⁻⁶ Ω*m, more in particular <10⁻⁷ Ω*m, such as <5*10⁻⁸ Ω*m, and or wherein the resistivity of the at least one longitudinal piece of memory metal is in particular <10% of the resistivity of human tissue, such as inside the throat, more in particular <1% thereof, such as <0.1% thereof.

In an exemplary embodiment of the present single cell cylindrical battery the at least one longitudinal piece of memory metal is embedded in an opening, wherein the opening is provided between the positive terminal and the negative terminal, in particular in an insulation material between the positive terminal and the negative terminal.

In an exemplary embodiment of the present single cell cylindrical battery the opening comprises an electrically insulating material surrounding the at least one longitudinal piece, wherein said electrically insulating material is soluble in water or saliva, in particular a biopolymer, such as gelatine, polysaccharide, and gum. An example of such insulating material is Polyvinylpyrrolidone (PVP). A coating of insulating material is found to work equally well, such as a coating of 1-100 μm thick.

The above can be considered as a saliva and/or temperature activated fuse, albeit in the mechanical reversal. A piece of memory metal in the form of a wire or strip may be embedded in a cavity (channel/depth) of the gasket (i.e., in the plastic insulating ring between the cap and the can). This cavity forms an open connection between the metal cap (−) and can (+) (terminals) of the (button) cell. The cavity is typically located on the outside of the gasket, i.e. on the outside of the cell. The cavity is typically less deep than the height of the gasket, i.e. the cavity has no connection to the internal cell space. The reversed fuse may be a piece of memory wire that is electrically connected to either the cap or the can, or not. When the cell is manufactured, the wire may be shaped so that no electrical contact is made between can and cap. The wire is made from a memory metal that has been conditioned/composed so that shape change occurs at 35 C or higher (body temperature). The wire has a thickness such that it does not melt through when the cell discharges through it. The cavity in which the wire is attached may be filled and thus the wire is embedded (sheathed/electrically insulated) by an electrically insulating material: the fastener. This insulating material may be chosen in such a way that it completely dissolves when in contact with saliva or water for a certain time after swallowing. The solubility of the material is preferably >0.01 mole/l (@273 K), more preferably >0.1 mole/l, such as 0.5-10 mole/l, The energy of dissolution ΔG (273 K) is preferably relatively small, such as <20 KJ/mole. The material is preferably non-toxic. Typically the electrical conductivity of these materials as such, at 20° C., is <1 S/m, preferably <10⁻² S/m. If possible, a material that only dissolves properly at temperatures above 30° C. is chosen. After dissolution, the cavity is empty and the piece of memory wire has free space to deform and electrically interconnect the cap and can. The battery now discharges preferentially through the memory wire (reversed fuse) and not through the saliva and tissue with which the battery is in contact. Typically at least 1 cavity with piece of metal is provided on the perimeter of the gasket but preference is given to 2 or more distributed on the perimeter to maximize the chance of operation. The advantage of the combination of the memory wire and the soluble embedding material is that the longitudinal piece action is not only temperature activated but also salivary activated. Outside the body, this combination will not occur often so the risk of inadvertent activation is low. As an embedding material, for example, non-toxic polymeric materials such as gelatines, polysaccharides, and the like can be considered.

In an exemplary embodiment of the present single cell cylindrical battery the electrical fuse (f) comprises a thermally sensitive electrical insulation material, wherein the thermally sensitive material is adapted to accumulate energy at a rate higher than heat dissipation thereof, such as at a net rate of >0.1 W, and wherein the thermally sensitive electrical insulation material is adapted to provide heat to the electrical fuse over a heat up period of time >5 minutes such that in a sacrifice period of time of <30 minutes the electrical fuse is sacrificed. By heat-sensitive it is meant that the material either undergoes thermal melting, thermal degradation, or goes through its glass transition state upon exposure to a particular temperature range. Examples of heat sensitive matrix materials include natural and synthetic polymers. Most preferably, the matrix material is a wax. Alternatively, preferred synthetic polymers include but are not limited to polymers, typically relatively small polymers with a molecular weight of <100 Da, such as polyethylene, polypropylene, cellulose acetate, polyester, polystyrene, polyamide, polycarbonate, polyolefin, fluoropolymer, polyvinyl chloride, polyurethane, and polyimide polymers. The heat-sensitive matrix material does not need to be limited to a particular homopolymer but may also be comprised of a polymer blend. As such the thermally sensitive material is considered to accumulate relative small, but significant, amounts of heat over time, such that at normal, not too long operational conditions, the fuse is not sacrificed, and during relatively long and increased operation conditions, such as when swallowed, the fuse is sacrificed. Therewith the battery operates as expected, whereas at higher and prolonged operation the fuse melts and an electrical current stops from flowing.

In an exemplary embodiment of the present single cell cylindrical battery the at least one fuse comprises at least one dielectric layer (d), and embedded in said dielectric layer at least one electrically conducting wire (w). The term “wire” may refer to a wire, such as a wire with a circular cross-section, and likewise to a conducting path between two points, such as a (thin) line of conducting material, in particular a substantially flat line. A sheet or the like may be provided, wherein the sheet is made of said at least one dielectric material, and the at least one electrically conducting wire is incorporated there-in. The wire is typically in electrical contact with two electrically conducting terminals on either side of said dielectric layer.

In an exemplary embodiment of the present single cell button battery the fuse is in between the positive terminal, also referred to as can, and the positive electrode, and/or the fuse is in between the negative terminal, also referred to as cap, and the negative electrode, thereby replacing a direct electrical contact of said electrode with the respective terminal by an electrical contact through the fuse via fuse terminals.

In an exemplary embodiment of the present single cell button battery the electrically conducting terminals of the fuse comprise a material such as aluminium, nickel, stainless steel, gold or another material that is electrochemically stable at the potential of the contacted electrode.

In an exemplary embodiment of the present single cell cylindrical battery the fuse has a thickness of 10-300 μm, preferably 20-100 μm, more preferably 30-70 μm, such as 40-60 μm. In this respect the term “fuse” refers to a total thickness, optionally including elements as depicted in FIGS. 4a-c. The fuse is therewith relatively thin, and forms no mechanical barrier for implementing into a battery. It also has a limited impact on the battery capacity. Also, the thin fuse prevents short circuitry rather quickly, typically within a few seconds, such as within one or two seconds.

In an exemplary embodiment of the present single cell cylindrical battery the dielectric material is selected from cellulose comprising materials, such as paper, from polymeric materials, from glass, from fibrous material, from a gas, in particular air, or a combination thereof. The selected dielectric material being stable against the constituents (solvents) of the liquid electrolytes used. These types of materials can be implemented in a battery without jeopardizing other functionality thereof, and in addition are easy to implement.

In an exemplary embodiment of the present single cell button battery the fuse embedded in the dielectric material is crossing a cavity within said dielectric material there-with forming a conductive path, in particular a cavity that is filled with a gas, such as helium, or argon, or wherein said cavity is vacuum, with a lower heat conductivity then the dielectric material. Said fuse conductive path is thereby fully or partly suspended in vacuum or gas.

In an exemplary embodiment of the present single cell button battery the fuse conducting path (w) has a cross sectional area of <2000 μm², more preferably <500 μm², such as 1-100 μm².

In an exemplary embodiment of the present single cell button battery the fuse conducting path (w) has a circular cross sectional area with a diameter <100 μm, more preferably <50 μm, such as 1-10 μm.

In an exemplary embodiment of the present single cell button battery the fuse is sacrificed (blown) at a power of >100 W (I²V), preferably at a power of >1W, more preferably at a power of >0.1 W, such as >0.05W, in particular sacrificed in a time <60 sec, preferably <10 sec, such as <5 sec, more in particular sacrificed at a peak-current of >1A, preferably >0.5A, more preferably >0.2 A, such as >0.1A. Likewise the fuse is sacrificed (blown) after an energy consumption within the give times of >1000 J, in particular >10 J, more in particular >1 J, such as >0.1 J. The fuse can be designed in view of a typical use in combination with its function to be sacrificed.

In an exemplary embodiment of the present single cell cylindrical battery the wire has a diameter (or equivalent dimension) of 10-200 μm, preferably 20-100 μm, more preferably 30-70 μm, such as 40-60 μm. In addition to a relatively thin wire, or as an alternative thereto, the wire may have a limited width as well, therewith contributing to preventing short circuitry.

In an exemplary embodiment of the present single cell cylindrical battery the fuse wire has a melting point of <100° C., preferably <60° C., e.g. in order to prevent burns and in order to act quickly as a fuse.

In an exemplary embodiment of the present single cell cylindrical battery the fuse wire has a resistivity of <100Ω, preferably <10Ω, more preferably <5Ω, such as <1Ω.

In an exemplary embodiment of the present single cell cylindrical battery the fuse wire comprises an electrically conductive material such as aluminium, nickel, tin, copper, lead, silver, stainless steel, or a combination thereof, preferably copper.

In an exemplary embodiment of the present single cell cylindrical battery the negative terminal is an insulated top cap.

In an exemplary embodiment of the present single cell cylindrical battery the positive terminal is a metallic bottom.

In an exemplary embodiment of the present single cell cylindrical battery the electrolyte comprises a conductive material such as silver, alkaline, mercury, zinc, lithium, or a combination thereof.

In an exemplary embodiment of the present single cell cylindrical battery the electrode each individually comprise a conductive material such as zinc, lithium, Mn, Ni, Ag, C, Cu, or oxides thereof, or fluorides thereof.

In an exemplary embodiment of the present single cell cylindrical battery the battery provides a nominal voltage of 0.1-5 V, preferably 1-4V, such as 2-3 V. It is noted that even batteries that under intended circumstances do not provide much power anymore, and hence may be considered to be (fully) used, still can cause the upper digestive tract injuries.

In an exemplary embodiment of the present single cell cylindrical battery the battery provides a current of 100-2000 mA, preferably 150-1000 mA, such as 200-500 mA.

In an exemplary embodiment of the present single cell cylindrical battery the battery provides a capacity of 100-2000 mAh, preferably 150-1000 mAh, such as 200-500 mAh.

In an exemplary embodiment of the present single cell cylindrical battery the single cell cylindrical battery has a diameter of 4-44 mm, preferably 5.8-24.5 mm, more preferably 7.9-23.0 mm, such as 10.0-20.0 mm (diameter typically +0.15 mm), and a height of 1-10 mm, preferably 1.6-5.4 mm, more preferably 2.5-3.2 mm, as these types of batteries are found to cause most of the injuries and so on. In particular batteries of types YY20XX, such as CR20XX, and in particular CR2016, CR2020, CR2025, and CR2032 are considered.

In an exemplary embodiment of the present single cell cylindrical battery comprises a housing for providing structural integrity, such as wherein the at least one positive electrode is a can and the at least one negative electrode is a cap.

In an exemplary embodiment of the present single cell cylindrical battery the fuse comprises a fuse top (1) and a fuse bottom (2) of an electrically insulating material, a fuse top contact (3) and a fuse bottom contact (6) incorporated in the fuse top (1) and fuse bottom (2), respectively, a fuse center contact (4) and a fuse ring contact (7) in between the fuse top (1) and fuse bottom (2), wherein the fuse (5) is in electrical contact with the fuse ring contact (7) and the fuse center contact (4), wherein the fuse center contact (4) is in electrical contact with the fuse bottom contact (6), and wherein the fuse ring contact (7) is in electrical contact with the fuse top contact (3).

In an exemplary embodiment of the present single cell cylindrical battery an optical fuse symbol at an outside of the battery is provided, in particular a fuse system according to FIG. 6.

In an exemplary embodiment of the present single cell cylindrical battery an optical symbol at an outside of the battery is provided indicative of a broken fuse.

The invention will hereafter be further elucidated through the following examples which are exemplary and explanatory of nature and are not intended to be considered limiting of the invention. To the person skilled in the art it may be clear that many variants, being obvious or not, may be conceivable falling within the scope of protection, defined by the present claims.

### FIGURES

FIG. 1-3, 4a-c show schematics of the present device,

FIG. 5 shows a worked open version of a battery,

FIG. 6 shows electrical fuse symbols, and

FIGS. 7, 8a-b, 9a-c show embodiments.

### DETAILED DESCRIPTION OF FIGURES

In the figures:
eₚ at least one positive electrode
eₙ at least one negative electrode
eⱼ in between said electrodes at least one solid or fluid electrolyte
tₚ at least one positive terminal in electrical contact with the at least one positive electrode
tₙ at least one negative terminal in electrical contact with the at least one negative electrode
f at least one electrical fuse
d at least one dielectric layer
w at least one electrically conducting wire
100 Single cell cylindrical battery
1 fuse top
2 fuse bottom
3 top contact fuse
4 center contact fuse
5 fuse wire
6 bottom contact fuse
7 ring contact fuse
10 fuse
11 fuse bottom part
12 fuse top part
21 anode
22 cathode
23 bottom cup
24 top cup
25 separator
26 insulating gasket

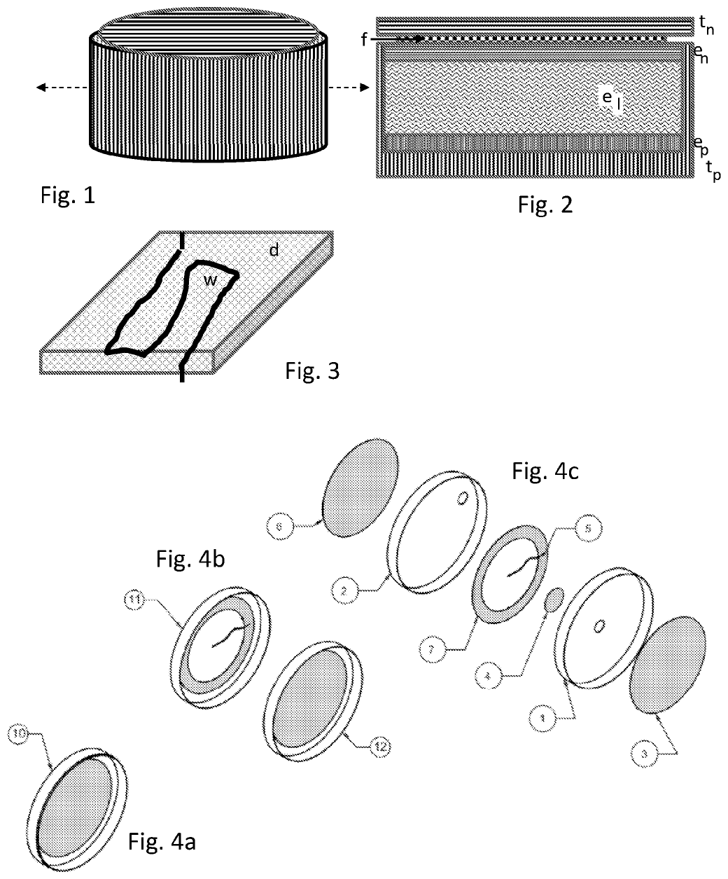

FIG. 1 shows a schematic layout of a typical single cell cylindrical battery, with a height and diameter.

FIG. 2 shows a detailed cross-sectional layout with a single cell cylindrical battery, such as a button cell or a button battery, comprising at least one positive electrode (ep), at least one negative electrode (eₙ), in between said electrodes at least one solid or fluid electrolyte (eₗ), at least one positive terminal (tₚ) in electrical contact with the at least one positive electrode, at least one negative terminal (tₙ) in electrical contact with the at least one negative electrode, and at least one electrical fuse (f) in between and in electrical contact with said negative or positive electrode and said negative or positive terminal, respectively, and wherein the at least one fuse comprises at least one dielectric layer (d), and embedded in said dielectric layer at least one electrically conducting wire (w) (see FIG. 3 for top view details).

Such a cell has been tested by sub-merging it in a liquid that resembles the electrical conductivity of a throat environment. The liquid comprised a standard Ringer's lactate solution (Ringer's lactate solution comprises: 130-131 mEq of sodium ion=130 mmol L⁻¹, 109-111 mEq of chloride ion=109 mmol L⁻¹, 28-29 mEq of lactate ion=28 mmol L⁻¹, 4-5 mEq of potassium ion=4 mmol L⁻¹, 2-3 mEq of calcium ion=1.5 mmol L⁻¹, and has a pH of 6.5. The acidity of the mouth is typically pH 6.2-7.4.). The CR2032 battery was sub-merged therein, wherein the battery was adapted to comprise the present fuse. A rapid breaking of short circuitry was observed by measuring the current provided by the battery, typically within 0.2 seconds. As such, effects of an ingested battery, such as damage to the esophagus, such as chemical reactions, are found to be reduced significantly. This model experiment predicts a reduction of >90%, and typically >99%, leaving only minor effects present, as it takes some time for the fuse to break. In such an experiment the result of short-circuiting a Duracell CR2016 battery, showed a cloud of oxidation material (mainly NiO₂) and bubbles of hydrogen gas.

FIGS. 4a-c show details of the present fuse. Therein an example is built up of small elements. The fuse 10 is formed as a circular-shaped element which can be integrated/incorporated within an existing battery. An example for the battery taken is a CR2032. The fuse has a fuse bottom part 11 and a fuse top part 12. Therein elements as a fuse top 1, a fuse bottom 2, a fuse top contact 3, a fuse center contact 4, a fuse wire 5, a fuse bottom contact 6, and a fuse ring contact 7 can be seen. The fuse itself electrically contacts ring 7 and center 4. The whole fuse is in contact with an electrical terminal of the battery by bottom contact 6 and with an adjacent electrode of the battery by contact 3. The fuse bottom 2 and fuse top 1 are typically made of an electrically insulating material, such as a dielectric, or cellulose, as explained in the description. An electrical current therefore passes from a terminal to contact 6, to ring contact 7, via the fuse 5 to central contact 4, then to fuse top contact 3, and further to an electrode.

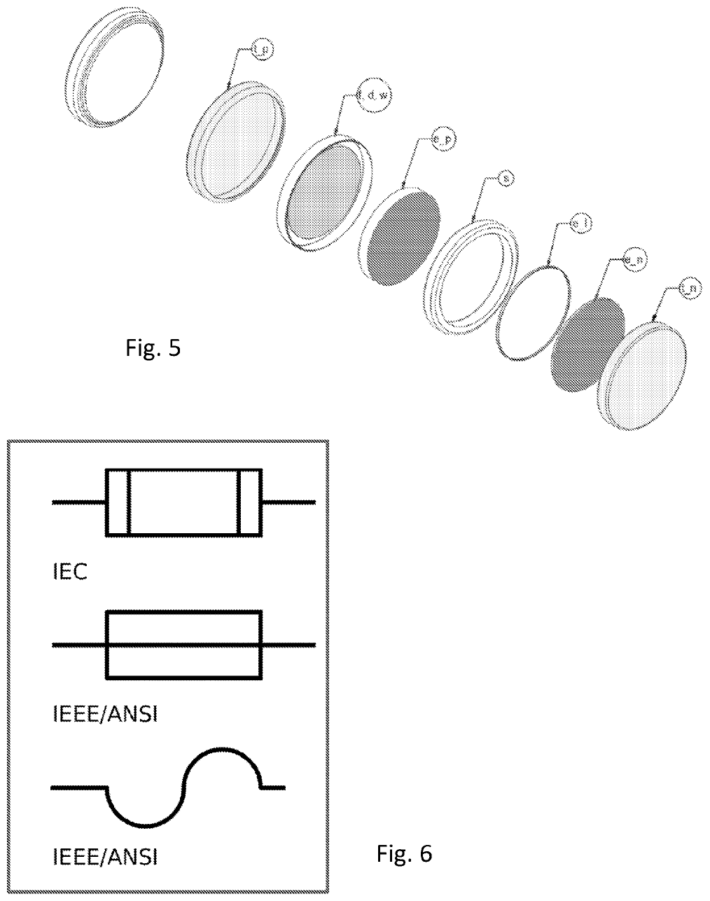

FIG. 5 shows a work-open version of the present button cell battery. Therein the at least one positive terminal tₚ in electrical contact with the at least one positive electrode eₚ, with the present fuse comprising at least one dielectric layer d, and at least one electrically conducting wire w, in between said electrodes at least one solid or fluid electrolyte eₗ, at least one negative electrode eₙ, and at least one negative terminal to in electrical contact with the at least one negative electrode.

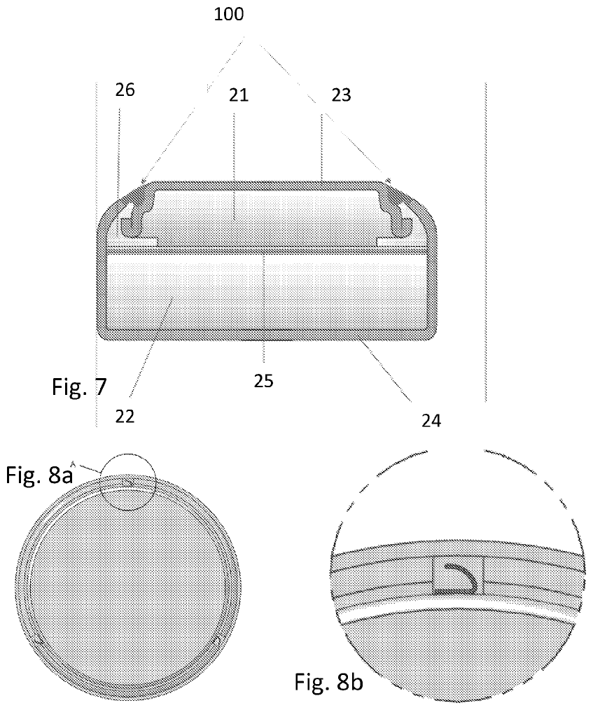

FIG. 6 shows three typically used symbols for an electrical fuse.

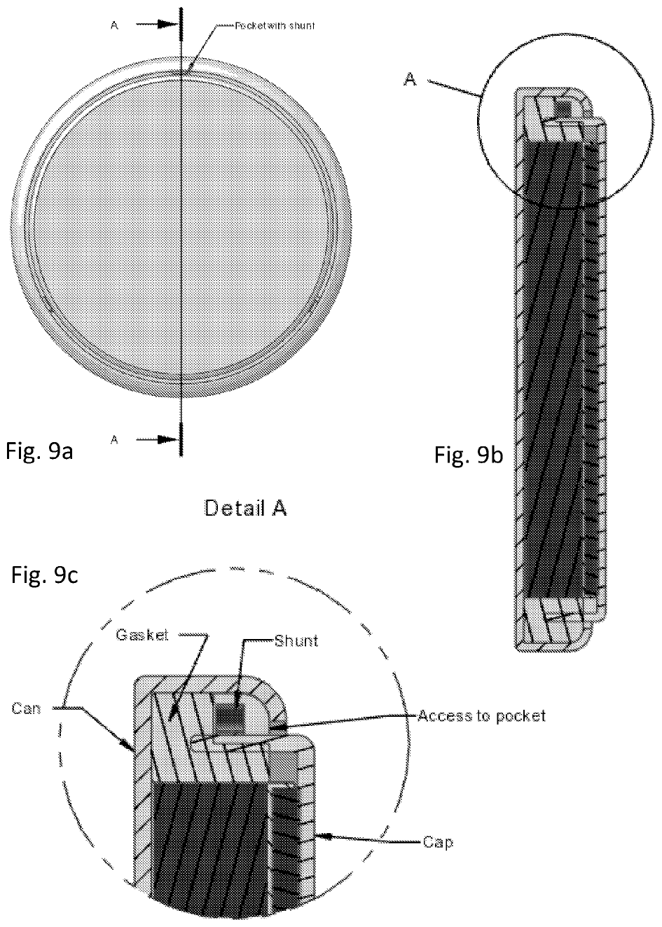

FIG. 7 shows an exemplary button cell battery with SPCA, as detailed above, comprising an anode 21, a cathode 22, a top and bottom cup 23,24, a separator 25 and an insulating gasket 26.

FIG. 8a show a top view of a button cell, and FIG. 8b a detail of the present fuse, in contact with one terminal only.

FIG. 9a show a top view of a button cell, FIG. 9b a cross-section A-A, and FIG. 9c a detail showing the can, a gasket, the present shunt, access to the pocket through an opening, and the cap. The shunt may be surrounded by an insulation material between the positive terminal and the negative terminal. The opening comprises an electrically insulating material surrounding the at least one longitudinal piece, wherein said electrically insulating material is soluble in water or saliva.

1. A single cell cylindrical battery selected from a button cell and a button battery, comprising
at least one positive electrode,
at least one negative electrode,
in between said electrodes at least one electrolyte selected from a solid electrolyte and a fluid electrolyte,
at least one positive terminal in electrical contact with the at least one positive electrode,
at least one negative terminal in electrical contact with the at least one negative electrode, and
at least one electrical fuse in between and in electrical contact with said negative or positive electrode and said negative or positive terminal, respectively,
wherein the at least one fuse comprises a dielectric material, forming at least one dielectric layer, and wherein the at least one electrical fuse is embedded in said dielectric material.

2. The single cell cylindrical battery according to claim 1, wherein the electrical fuse comprises a short peak current amplifier.

3. The single cell cylindrical battery according to claim 1, wherein the electrical fuse comprises at least one longitudinal piece of memory metal, wherein the at least one longitudinal piece is in contact with said negative terminal and said positive terminal at a temperature above 30° C., and wherein the at least one longitudinal piece is not in contact with at least one of said negative terminal and said positive terminal at a temperature below 30° C.

4. The single cell cylindrical battery according to claim 3, wherein the at least one longitudinal piece of memory metal is embedded in an opening, wherein the opening is provided in an insulation material between the positive terminal and the negative terminal, and wherein the opening comprises an electrically insulating material surrounding the at least one longitudinal piece, wherein said electrically insulating material is soluble in one of water and saliva.

5. (canceled)

6. The single cell cylindrical battery according to claim 1, wherein the electrical fuse comprises a thermally sensitive electrical insulation material, wherein the thermally sensitive material is adapted to accumulate energy at a rate higher than heat dissipation thereof, such as at a net rate of >0.1 W, and wherein the thermally sensitive electrical insulation material is adapted to provide heat to the electrical fuse over a heat up period of time >5 minutes such that in a sacrifice period of time of <30 minutes the electrical fuse is sacrificed.

7. The single cell cylindrical battery according to claim 1, embedded in said dielectric layer at least one electrically conducting wire.

8. The single cell cylindrical battery according to claim 1, wherein the fuse is in between the positive terminal and the positive electrode, and/or wherein the fuse is in between the negative terminal and the negative electrode.

9. The single cell cylindrical battery according to claim 1, wherein the fuse comprises fuse terminals from a material that is electrochemically stable at the operating potential of the battery.

10. The single cell cylindrical battery according to claim 1, wherein the dielectric material comprises a cavity, and the fuse embedded in the dielectric material forms a conductive path over said cavity, wherein the cavity is filled with a gas with a lower heat conductivity then the dielectric material.

11. The single cell cylindrical battery according to claim 10, wherein the fuse conducting path has a cross sectional area of <2000 μm².

12. The single cell cylindrical battery according to claim 10, wherein the fuse conducting path has a circular cross sectional area with a diameter<100 μm.

13. The single cell cylindrical battery according to claim 1, wherein the fuse has a thickness of 10-200 μm, and
wherein the wire has a diameter of 10-200 μm, and
wherein the fuse is sacrificed at a power of >100 W, and
wherein the fuse is sacrificed in a time <60 sec, and
wherein the fuse is sacrificed at a peak current of >1A, and
wherein an optical fuse symbol at an outside of the battery is provided, and
wherein an optical symbol at an outside of the battery is provided indicative of a broken fuse.

14. The single cell cylindrical battery according to claim 1, wherein the dielectric material is selected from cellulose comprising materials, from polymeric materials, from glass, from fibrous material, from a gas, and a combination thereof.

15. The single cell cylindrical battery according to claim 1, wherein the fuse wire has a melting point of <100° C., and wherein the fuse wire has a resistivity of <100Ω, and wherein the fuse wire comprises an electrically conductive material, and
wherein the negative terminal is an insulated top cap, and
wherein the positive terminal is metallic bottom.

16. The single cell cylindrical battery according to claim 1, wherein the anode comprises a conductive material and
wherein the electrode each individually comprise a conductive.

17. The single cell cylindrical battery according to claim 1, wherein the battery provides a nominal voltage of 0.1-5 V, and/or a current of 100-2000 mA, and a capacity of 100-2000 mAh.

18. The single cell cylindrical battery according to claim 1, wherein the single cell cylindrical battery has a diameter of 4-44 mm, and a height of 1-10 mm.

19. The single cell cylindrical battery according to claim 1, comprising a housing for providing structural integrity.

20. The single cell cylindrical battery according to claim 1, wherein the fuse comprises a fuse top and a fuse bottom of an electrically insulating material, a fuse top contact and a fuse bottom contact incorporated in the fuse top and fuse bottom, respectively, a fuse center contact and a fuse ring contact in between the fuse top and fuse bottom, wherein the fuse is in electrical contact with the fuse ring contact (and the fuse center contact, wherein the fuse center contact is in electrical contact with the fuse bottom contact, and wherein the fuse ring contact is in electrical contact with the fuse top contact.

21. A method of preventing esophageal injury after accidental ingestion of a single cell cylindrical battery by children, by small sized adults, by people with a mental limitation, by people with a prior narrowing of digestive or upper respiratory tract, by ingestion in the mouth, by ingestion in the nose, by ingestion in the pharynx, the method comprising: providing the single cell cylindrical battery that comprises:
at least one positive electrode,
at least one negative electrode,
in between said electrodes at least one electrolyte selected from a solid electrolyte and a fluid electrolyte,
at least one positive terminal in electrical contact with the at least one positive electrode,
at least one negative terminal in electrical contact with the at least one negative electrode, and
at least one electrical fuse in between and in electrical contact with said negative or positive electrode and said negative or positive terminal, respectively,
wherein the at least one fuse comprises a dielectric material forming at least one dielectric layer, and wherein the at least one electrical fuse is embedded in said dielectric material, and
preventing a short circuit by the at least one electrical fuse, which at least one electrical fuse breaks the circuit when ingested.

22. (canceled)
